(19) United States
(12) Patent Application Publication
(10) Pub. No.: US 2022/0248188 A1
(43) Pub. Date: Aug. 4, 2022

(54) RECONFIGURABLE MEANS FOR ALERTING A MOBILE DEVICE

(71) Applicant: Benjamin T. Jones, Las Vegas, NV (US)

(72) Inventor: Benjamin T. Jones, Las Vegas, NV (US)

(21) Appl. No.: 17/591,892

(22) Filed: Feb. 3, 2022

Related U.S. Application Data
(60) Provisional application No. 63/145,764, filed on Feb. 4, 2021.

(51) Int. Cl. H04W 4/12; H04W 4/80; H04W 4/38; H04W 4/021

(52) U.S. Cl. CPC H04W 4/12; H04W 4/021; H04W 4/38; H04W 4/80

(57) ABSTRACT

The present invention is directed to a system and method for alerting a mobile device using a reconfigurable article. A housing includes an inner chamber which holds a coded image and/or NFC tag. An enrollment event is used to associate the coded image and/or NFC tag with a phone number or other communication means. When a mobile device scans the coded image and/or NFC tag, an alert is transmitted to a device associated with the phone number in the form of a text message, call, or video call. Association of the coded image and/or NFC tag with the recipient phone number is able to be canceled by the owner of the recipient phone number at any time and additional coded images and/or NFC tags are able to be associated with the recipient phone number at any time.

### CROSS REFERENCE TO OTHER APPLICATIONS

This application is related to and claims priority from the following U.S. patents and patent applications. This application claims priority from U.S. Provisional Application No. 63/145,764, filed Feb. 4, 2021, which is incorporated herein by reference in its entirety.

### BACKGROUND OF THE INVENTION

### 1. Field of the Invention

The present invention relates to methods of transmitting alerts to an individual, and more specifically to sending alerts to a user device based on scanning of an image with an embedded code.

### 2. Description of the Prior Art

It is generally known in the prior art to provide means for alerting the owner of a home via the ringing of a doorbell, most often initiated by the pressing of a button. It is further known to provide a smart doorbell, which is capable of admitting an individual to a home or other space based on whether the individual presents one of a predetermined number of QR codes to a camera attached to the smart doorbell.

Prior art patent documents include the following:

US Patent Publication No. 2020/0097996 for Digital Doorbell by inventor Shaffer, filed Nov. 27, 2019 and published Mar. 26, 2020, discloses a method and system for alerting an occupier of a dwelling that a visitor is at an entranceway of the dwelling. The method includes receiving a digital code associated with a QR code scan of a QR code positioned in proximity to the entranceway; determining an occupier status as to whether the occupier is to be disturbed or contactable; and sending a predetermined message to a mobile communications device of the visitor depending upon the occupier status.

US Patent Publication No. 2020/0349786 for Access management system by inventors Ho et al., filed Mar. 30, 2020 and published Nov. 5, 2020, discloses systems, apparatus, and methods for remotely managing access to a space and performing trust verification to authorize or deny people access to the space. An access management platform comprising an electronic lock installed on a door can enable a user to establish a virtual presence at the door. For example, a delivery person can activate a doorbell button or icon of the lock and the lock can send a message to a smartphone of a user of the platform. The user can remotely use the smartphone to initiate a video stream using a camera of the platform and a two-way audio stream. The user can use the smartphone to unlock the door and ask the delivery person to deliver the package inside. The platform can also determine and control the status of the space and communicate with other devices regarding the status of the space.

U.S. Pat. No. 10,708,410 for Systems and methods for controlling a locking mechanism using a portable electronic device by inventors Gerhardt et al., filed Jul. 15, 2019 and issued Jul. 7, 2020, discloses systems and methods for operating a remotely operable lock. In an example embodiment, a method comprises receiving credentials at a web service from a portable electronic device, authenticating the credentials, and based on a successful authentication, issuing a command for receipt by the lock from the web service or the portable electronic device.

U.S. Pat. No. 10,846,958 for Virtual intercom system by inventor Raduchel, filed Mar. 22, 2019 and issued Nov. 24, 2020, discloses methods, systems, and apparatus, including computer programs encoded on a computer storage medium, for a virtual intercom. In some implementations, a request from a visitor device to communicate with an occupant of a particular unit of the facility is received. A location of the visitor device is received. Based on the received location, it is determined that the visitor device is within a predetermined bounded area. An occupant profile is identified based on the received request. Information associated with the occupant profile is obtained. Based on the obtained information, it is determined the occupant has registered a profile. Based on the obtained information, a communication path to an occupant device is identified. The request from the visitor device is sent, using the communication path, to an occupant device belonging to the occupant. A response from the occupant device is received. Based on the response, an action is performed.

US Patent Publication No. 2018/0068506 for Entry managing system by inventors Lee et al., filed Sep. 6, 2016 and published Mar. 8, 2018, discloses an entry managing system connected to a door-lock device. The system controls a camera to start shooting a monitoring video of a monitoring region and stores the monitoring video in a memory when a doorbell trigger receives an operation of a visitor. The system decodes an authentication pattern to extract a visitor data when recognizing the authentication pattern in the monitoring video during shooting. The system controls the door-lock device to unlock when determining that the visitor data passes authentication. Via using the authentication pattern as an electronic key and using the camera to read the authentication pattern, the example not only can make it easy that the administrator configures and gives a key, but also can recognize the electronic key without an additional electronic-key-reading device.

US Patent Publication No. 2012/0044049 for Smart Doorbell Security System and Method to Identify Visitors by inventors Vig et al., filed Aug. 23, 2010 and published Feb. 23, 2012, discloses a device and method to identify visitors and notify the resident of the identified information of the visitor before the resident opens the door for the visitor. The device reads/scans the fingerprint of the visitor as they activate the Smart Doorbell Switch by pressing the Smart Doorbell Switch with their finger, preferably their thumb. Identifying information associated with the scanned fingerprint is retrieved and announced for the Resident. The visitor's fingerprint is also checked with an Alert Database to check if there is an alert tied to the fingerprint. If so, the appropriate authorities will be contacted and the resident will be alerted.

US Patent Publication No. 2013/0214902 for Systems and methods for networks using token based location by inventors Pineau et al., filed Sep. 7, 2012 and published Aug. 22, 2013, discloses devices that are operated dependent on a user's location being confirmed as in the vicinity of an unpowered token, such as an NFC chip or QR code. The tokens may be attached to the devices which will only operate if triggered by a user scanning the corresponding token with a personal mobile device. In other cases, the scanning of a token may cause a remote server to perform an action that depends on the user being in proximity to the token.

### SUMMARY OF THE INVENTION

The present invention relates to methods of transmitting alerts to a mobile device.

It is an object of this invention to provide a means for alerting a mobile device after recognition of an image with an embedded code or an identifying device, where the image or identifying device is easily reconfigurable to associate or disassociate with different mobile devices.

In one embodiment, the present invention is directed to a system for providing an alert, including a housing, at least one unique identifier within the housing, wherein the at least one unique identifier includes at least one coded image and/or at least one near-field communication (NFC) tag, a server, including a processor and a database, in network communication with at least one communication device, wherein the at least one unique identifier is enrolled to associate the at least one unique identifier with the at least one communication device, wherein the association between the at least one unique identifier and the at least one communication device is stored in the database, wherein, when the at least one unique identifier is scanned or detected by at least one visitor device, a message is automatically transmitted to the at least one communication device and/or a call is automatically initiated between the at least one communication device and the at least one visitor device, and wherein the at least one visitor device includes at least one smart phone, at least one tablet, and/or at least one wearable device.

In another embodiment, the present invention is directed to a system for providing an alert, including at least one unique identifier, wherein the at least one unique identifier includes at least one coded image and/or at least one near-field communication (NFC) tag, a server, including a processor and a database, in network communication with at least one communication device, wherein the at least one unique identifier is enrolled to associate the at least one unique identifier with the at least one communication device, wherein the association between the at least one unique identifier and the at least one communication device is stored in the database, wherein the at least one unique identifier is associated with a geofence, wherein, when the at least one unique identifier is scanned or detected by at least one visitor device, a message is automatically transmitted to the at least one communication device and/or a call is automatically initiated between the at least one communication device and the at least one visitor device, wherein the server is operable to receive location data from the at least one visitor device, and wherein the message is not transmitted to the at least one communication device and/or the call is not initiated between the at least one communication device and the at least one visitor device if the at least one visitor device is detected to be outside the geofence based on the received location data.

In yet another embodiment, the present invention is directed to a system for providing an alert, including a housing, including an inner chamber, a server, including a processor and a database, in network communication with at least one communication device, at least one unique identifier positioned within the inner chamber of the housing, wherein the at least one unique identifier includes at least one coded image and/or at least one near-field communication (NFC) tag, wherein the housing is substantially transparent, wherein the at least one unique identifier is enrolled to associate the at least one unique identifier with at least one communication device, wherein the association between the at least one unique identifier and the at least one communication device is stored in the database, and wherein, when the at least one unique identifier is scanned or detected by at least one visitor device, a message is automatically transmitted to the at least one communication device and/or a call is automatically initiated between the at least one communication device and the at least one visitor device.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1A illustrates a housing including a coded image according to one embodiment of the present invention.

FIG. 1B illustrates a housing including a coded image according to one embodiment of the present invention.

FIG. 1C illustrates a housing without a coded image according to one embodiment of the present invention.

FIG. 2 illustrates a back view of a coded image according to one embodiment of the present invention.

FIG. 3 illustrates an activation graphical user interface (GUI) according to one embodiment of the present invention.

FIG. 4 illustrates a schematic diagram of a device interacting with a temporary doorbell according to one embodiment of the present invention.

FIG. 5 illustrates a user dashboard for a management system for one or more temporary doorbells according to one embodiment of the present invention.

FIG. 6 illustrates a device manager page for a management system for one or more temporary doorbells according to one embodiment of the present invention.

FIG. 7 illustrates a push notification to open an application generated upon scanning a coded image according to one embodiment of the present invention.

FIG. 8 illustrates a settings GUI according to one embodiment of the present invention.

FIG. 9 illustrates a visitor history GUI according to one embodiment of the present invention.

FIG. 10 illustrates a quick response settings GUI according to one embodiment of the present invention.

FIG. 11 is a schematic diagram of a system of the present invention.

### DETAILED DESCRIPTION

The present invention is generally directed to methods of transmitting alerts to an individual.

In one embodiment, the present invention is directed to a system for providing an alert, including a housing, at least one unique identifier within the housing, wherein the at least one unique identifier includes at least one coded image and/or at least one near-field communication (NFC) tag, a server, including a processor and a database, in network communication with at least one communication device, wherein the at least one unique identifier is enrolled to associate the at least one unique identifier with the at least one communication device, wherein the association between the at least one unique identifier and the at least one communication device is stored in the database, wherein, when the at least one unique identifier is scanned or detected by at least one visitor device, a message is automatically transmitted to the at least one communication device and/or a call is automatically initiated between the at least one communication device and the at least one visitor device, and wherein the at least one visitor device includes at least one smart phone, at least one tablet, and/or at least one wearable device.

In another embodiment, the present invention is directed to a system for providing an alert, including at least one unique identifier, wherein the at least one unique identifier includes at least one coded image and/or at least one near-field communication (NFC) tag, a server, including a processor and a database, in network communication with at least one communication device, wherein the at least one unique identifier is enrolled to associate the at least one unique identifier with the at least one communication device, wherein the association between the at least one unique identifier and the at least one communication device is stored in the database, wherein the at least one unique identifier is associated with a geofence, wherein, when the at least one unique identifier is scanned or detected by at least one visitor device, a message is automatically transmitted to the at least one communication device and/or a call is automatically initiated between the at least one communication device and the at least one visitor device, wherein the server is operable to receive location data from the at least one visitor device, and wherein the message is not transmitted to the at least one communication device and/or the call is not initiated between the at least one communication device and the at least one visitor device if the at least one visitor device is detected to be outside the geofence based on the received location data.

In yet another embodiment, the present invention is directed to a system for providing an alert, including a housing, including an inner chamber, a server, including a processor and a database, in network communication with at least one communication device, at least one unique identifier positioned within the inner chamber of the housing, wherein the at least one unique identifier includes at least one coded image and/or at least one near-field communication (NFC) tag, wherein the housing is substantially transparent, wherein the at least one unique identifier is enrolled to associate the at least one unique identifier with at least one communication device, wherein the association between the at least one unique identifier and the at least one communication device is stored in the database, and wherein, when the at least one unique identifier is scanned or detected by at least one visitor device, a message is automatically transmitted to the at least one communication device and/or a call is automatically initiated between the at least one communication device and the at least one visitor device.

Presently, if the doorbell of a home is broken, there is no convenient way for individuals to alert a resident to their presence at the door. Simply knocking has a lower likelihood of effectively alerting the resident, as the sound of the knock often cannot carry through each room of the home, especially if the home is a larger house. While visitors that have the resident's number are usually able to call, text, or otherwise communicate their presence to the resident, other visitors, such as solicitors, delivery people, or less familiar guests are unable to communicate in this fashion and thus have a higher likelihood of being left unheard. Further, many residents are uncomfortable providing their phone number in the vicinity of the door to the home, in fear that the number might be spammed by advertisers or other individuals. Therefore, there is a need for an easily reconfigurable and simple to set up doorbell, which can replace existing doorbells or act as a replaceable doorbell in the event that the permanent one is rendered nonfunctional.

In addition, traditional doorbells are inadequate because the doorbell sound often fails to be heard by the resident, especially if the resident is using headphones or has difficulty hearing. Present doorbells also fail to alert a resident who is not currently at home that an individual has approached their home. One way of solving this issue is to alert one or more user devices of the resident instead of or in addition to simply using a doorbell that makes a noise within a home. By alerting the one or more user devices, the resident is both able to notice the doorbell while their hearing is impaired and is provided notice of an individual approaching their home without needing to be present in the home.

Furthermore, a system is needed to an event-specific means of notifying an individual to the presence of a guest near a building. When a building is rented for a closed event, it is often necessary to tightly regulate which individuals are allowed in the building, but the building often lacks a doorbell or other means of alerting the event organizers when an individual is waiting to be let in. This issue is further compounded when the event organizers are not currently in the building. Setting up an actual doorbell system quickly is often prohibitively expensive and time consuming and not likely to be allowed by the owner of the building. Therefore, a system is needed to provide a temporary means to alert the user device of an event organizer when an individual is at the entrance to a building where an event is being held.

Additionally, in situations when a driver parks their vehicle and then leaves to go elsewhere, other motorists or pedestrians are frequently in need to communicate with the driver. For example, if the vehicle's alarm begins to go off or if the driver is improperly parked, it is often advantageous to communicate with the driver before authorities or other parties take more immediate, and potentially drastic, action. Furthermore, in situations in which a vehicle is stolen, it would be desirable for third parties to be able to communicate the location of the vehicle to the vehicle owner. Therefore, there is need to provide a detachable identifier for a vehicle, whereby third parties are able to detect or scan the identifier in order to communicate an alert to the owner of the vehicle. It should be appreciated that the present invention is not limited to embodiments placing a doorbell on a vehicle or building, and could include placing a detachable identifier on any article, including, but not limited to, a laptop, a gun, a bag, clothing items, and/or other valuable items. If anyone of these items should become lost, a detachable identifier would assist third parties in contacting the owner of the items and ensure quicker and more successful recovery of lost items.

The present system provides an easily reconfigurable means of alerting a mobile device via the scanning of an image with an embedded code or recognition of an identifying device. In one embodiment, the image and/or identifying device is removably attached to a structure, such as the door or wall of a building, such that the image or identifying device acts as a sort of doorbell for a home or other structure.

Referring now to the drawings in general, the illustrations are for the purpose of describing one or more preferred embodiments of the invention and are not intended to limit the invention thereto.

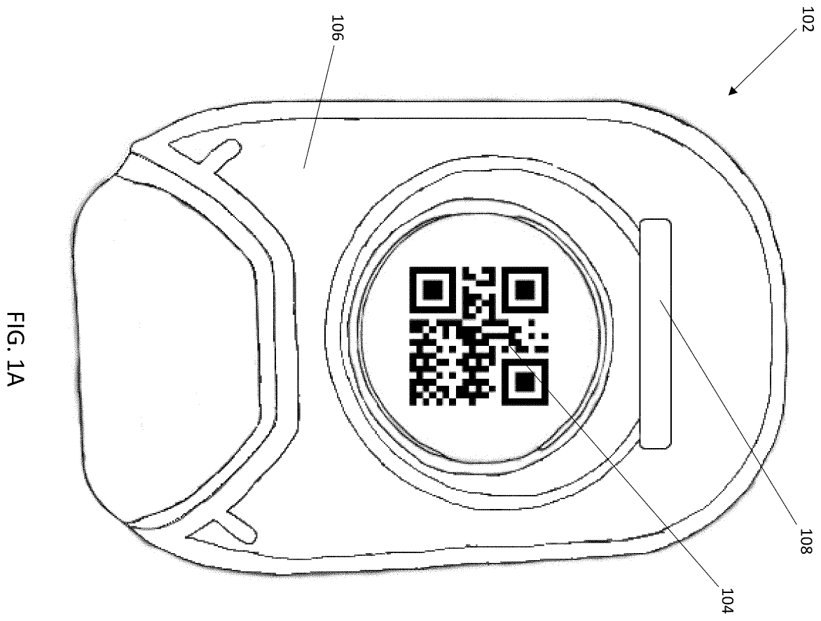

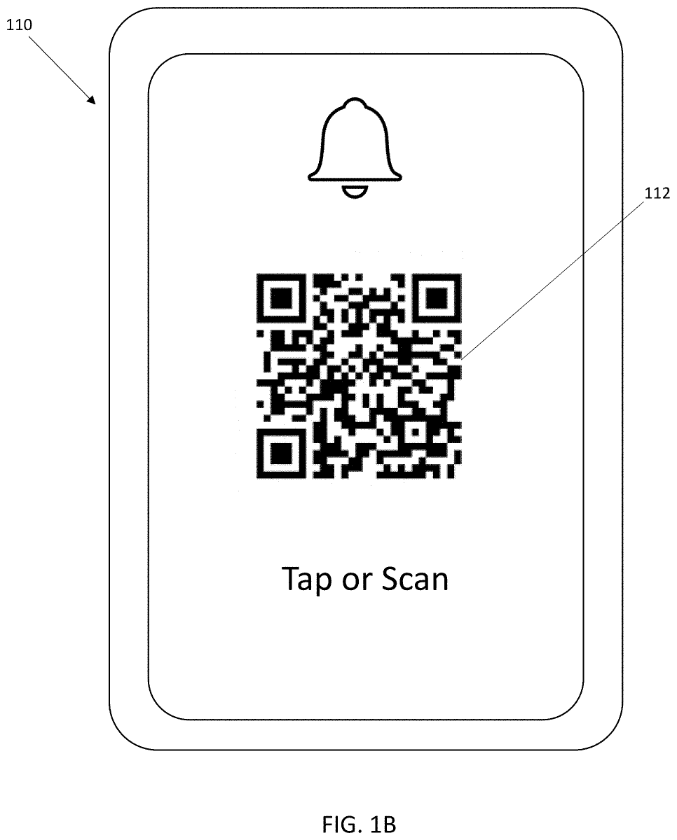

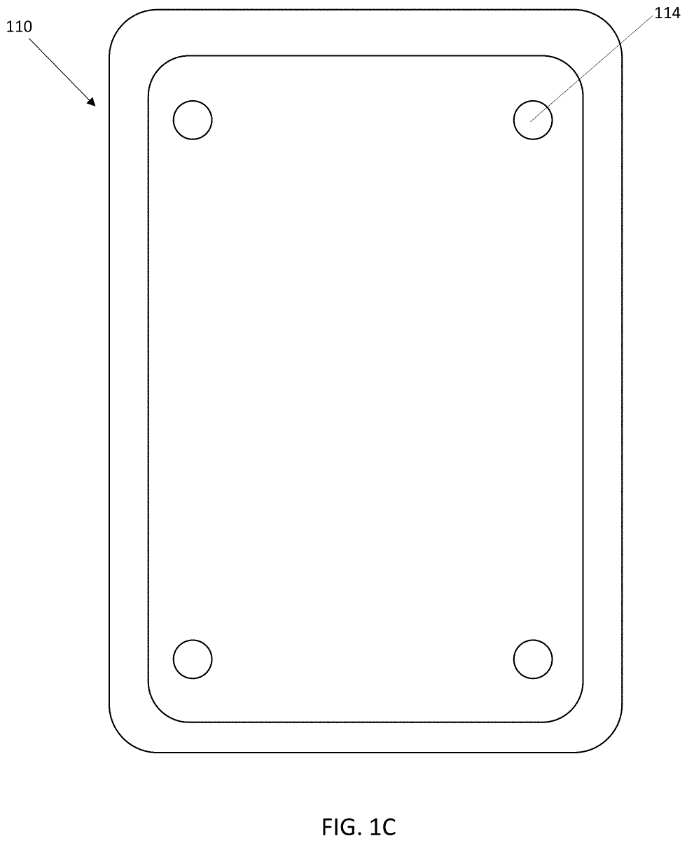

As shown in FIG. 1A, in one embodiment, the system includes a temporary doorbell 102 including a coded image 104 with an inner chamber of a housing 106. Because the temporary doorbell 102 is likely to be located on the exterior of a building or vehicle, putting the coded image within the housing 106 is useful in ensuring that the coded image 104 is not damaged by rain or other weather conditions. In one embodiment, the housing 106 includes an opening 108, through which the coded image 104 is able to be put into or taken out of the housing 106. The opening 108 allows a single housing 106 to be reconfigured to accommodate multiple different codes, which accommodates the use of a single housing 106 for multiple events and allows continued use of the housing 106 even in the event that the coded image 104 needs to be changed. In another embodiment, the side of the housing 106 opposite that of the coded image 104 includes a means for attaching (e.g., an adhesive substance) the housing 106 to the surface of an object. In one embodiment, the coded image 104 includes at least one QR code and/or barcode. In one embodiment, the housing is substantially transparent such that the coded image 104 within the housing 106 is able to be seen and identified from outside of the housing 106. In another embodiment, the temporary doorbell 102 includes a near-field communication (NFC) tag in addition to or instead of the coded image 104. The NFC tag is able to be put into or taken out of the housing 106 via the opening 108 such that the NFC tag within the temporary doorbell 102 is able to be replaced.

In one embodiment, the temporary doorbell 102 includes a securing mechanism for closing the opening 108. In one embodiment, the securing mechanism includes a screw, bolt, zipper, hook and loop mechanism, adhesive, and/or another means for shutting the opening. The inclusion of a securing mechanism both assists in protecting the contents of the temporary doorbell 102 from weather related effects and discourages third parties from tampering with the temporary doorbell 102 and entering their own coded image and/or NFC tag into the opening 108.

In another embodiment, the temporary doorbell includes a plastic covering with an ejection slot and a placement slot and an opening at the top. The ejection slot is closer to the top of the plastic covering, while the placement slot is closer to the bottom. When an NFC tag and/or coded image is placed into the opening at the top of the plastic covering, gravity assists the movement of the NFC tag and/or coded image into the placement slot at the bottom of the plastic covering. In order to remove the NFC tag and/or coded image, a user pushes the plastic covering and slides the NFC tag and/or coded image slightly upward. Once the NFC tag and/or coded image has been slid slightly upward, the bottom of the plastic covering can be pressed to pop the NFC tag and/or coded image into the ejection slot, where it can be more easily removed. If once the NFC tag and/or coded image is slid upward, the user then relieves pressure on the plastic covering, then the NFC tag and/or coded image is able to slide back into the placement slot. In another embodiment, in order to remove the NFC tag and/or coded image, the user activates a pin or flexing clasp attached to the plastic covering. Requiring that the user press into the plastic covering and activate a release mechanism helps the NFC tag and/or coded image to remain within the plastic covering, with decreased risk that it falls out or is forced out due to a weather event.

In one embodiment, the coded image is printed on a polymer substrate (e.g., polyvinyl chloride (PVC)). In one embodiment, the coded image is printed with dye-sublimation techniques, such that the ink forming the coded image on the polymer substrate does not bleed, even after prolonged contact with water.

In one embodiment, the housing 106 is formed from at least one plastic material. In one embodiment, the housing 106 includes at least tough plastic material, such as polycarbonate, polyethylene terephthalate, or polyurethane. Forming the device from a tough plastic material allows the device to better withstand weather events and last longer such that it is able to be reused multiple times. In another embodiment, the housing 106 includes at least one biodegradable polymer, such as polylactic acid, polyglycolic acid, cellulose derivatives, chitosan, and/or polyhydroxyalkanoates. Forming the housing 106 from a biodegradable polymer is especially useful in the event that the housing 106 falls and is lost. Because the housing 106 is formed from a biodegradable polymer, it does not form long-lasting waste for the user, but instead dissolves relatively quickly and is able to be replaced. In another embodiment, the housing includes an ultraviolet (UV) overlaminate, which helps to prevent the coded image and/or NFC tag from degrading quickly from the effects of sunlight or other UV sources.

In one embodiment, the housing includes an offset element in order to separate the coded image and/or NFC tag from the structure to which the temporary doorbell 102 is attached. Separation from the structure helps to ensure that the NFC tag does not suffer interference with the material of the structure. This is especially important in the case of metal structures, wherein magnetic interference is capable of causing disruption if the NFC tag and metal structure are too close. Alternatively, in another embodiment, the temporary doorbell 102 includes an anti-metal backing, such as a layer of ferrite material, which prevents magnetic interference.

In one embodiment, the housing includes one or more attachment means for attaching the housing to an object (e.g., a car, a surface of a house, a personal item, etc.). In one embodiment, an external surface of the housing includes an adhesive material operable to stick to an object. In another embodiment, the housing includes at least one hole configured to receive a screw, a nail, and/or a hook for attaching the housing to the object. In still another embodiment, an external surface of the housing is attached to a hook-and-loop material operable to attach to a corresponding hook-and-loop material applied to an external surface of the object. One of ordinary skill in the art will understand that the above mentioned attachment mechanisms are not intended to be limiting and that other attachment mechanisms known in the art are also able to be used for the present invention.

In one embodiment, the coded image 104 and/or the NFC tag are not within a housing. In one embodiment, the coded image 104 includes an adhesive backing, allowing it to be directly applied to objects as a sticker.

FIG. 1B illustrates a housing including a coded image according to one embodiment of the present invention. In one embodiment, the housing 110 includes a coded image 112. In one embodiment, the housing 110 does not include a front panel, leaving the coded image 112 exposed and able to be detected using a camera on a user device. In one embodiment, the coded image 112 is able to be removed from the housing 110 by pushing down on the coded image 112 and sliding it downwardly out of the housing 110.

FIG. 1C illustrates a housing without a coded image according to one embodiment of the present invention. In one embodiment, the housing 110 includes a plurality of openings 114. In one embodiment, the plurality of openings 114 are configured to accept a screw or a nail for attaching the housing 110 to another object (e.g., the side of a house). After the housing 110 is affixed to a surface, the coded image is then able to be inserted into the housing 110.

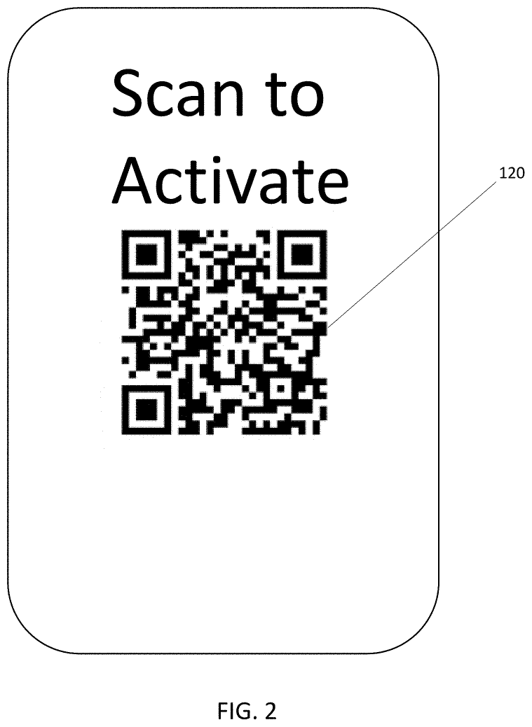

FIG. 2 illustrates a back view of a coded image according to one embodiment of the present invention. In one embodiment, the NFC tag and/or coded image includes a secondary coded image 120 (e.g., another QR code) on the side or back of the NFC tag and/or coded image. The enrollment event begins when the secondary coded image 120 is scanned by a mobile device, which automatically allows the mobile device to provide information regarding the social media account, phone number, email, or other communication means with which to associate the NFC tag and/or coded image.

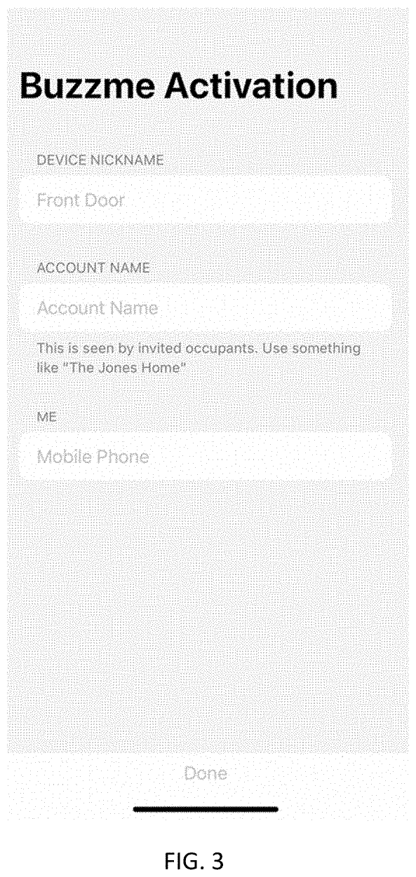

FIG. 3 illustrates an activation graphical user interface (GUI) according to one embodiment of the present invention. The coded image 104 is able to be enrolled through an enrollment event, which associates the coded image 104 with a particular phone number. Before being enrolled, the coded image 104 is not associated with any particular phone number. In one embodiment, the coded image 104 is enrolled via a software application on a user device, which scans the coded image 104 and transmits information regarding the association to an enrollment database. In another embodiment, the coded image 104 is associated with a phone number after it is imaged by a native camera application on a user device. In one embodiment, after using a camera to image the coded image 104, a prompt is generated on the user device to select whether the coded image 104 should be automatically associated with the phone number of the device being used to take the image or if a different phone number should be associated with the coded image 104. In one embodiment, a prompt is generated on the user device to enter a password, biometric signature, answers to challenge questions, and/or other authentication means in association with the coded image 104. The coded image 104 is operable to be disassociated from the phone number at any time via selecting an option to disassociate on a website or application associated with the coded image 104. In one embodiment, a password, biometric signature, answers to challenge questions and/or other authentication means previously associated with the coded image 104 is required in order to disassociate the coded image 104 from the phone number. After the coded image 104 is disassociated from a phone number, scanning the coded image 104 will no longer cause an alert to be transmitted to the phone number. In one embodiment, as shown in FIG. 3, the server receives a device nickname (e.g., Front Door), an account name, and/or an associated mobile number for the newly registered coded image. In one embodiment, the account name is visible to visitor devices that scan the coded image.

In one embodiment, during enrollment of the coded image 104 with the user device, a server receives information from the user device regarding whether the user device is already associated with an existing profile or whether the user device is not associated with any existing profile. If the user device is not associated with any existing profile, then the server automatically transmits a prompt to the user device to generate a new user profile, including a username, a password, one or more associated communication means (e.g., email address, phone number, etc.), one or more challenge question answers, personal information, and/or preference information regarding the at least one coded image. In one embodiment, the preference information regarding the at least one coded image includes what occurs when the coded image is scanned by a visitor device (e.g., is a text message sent to the user device, is a video call automatically started, etc.). In one embodiment, a user profile is not required to be created in order to associate the temporary doorbell with the communication means.

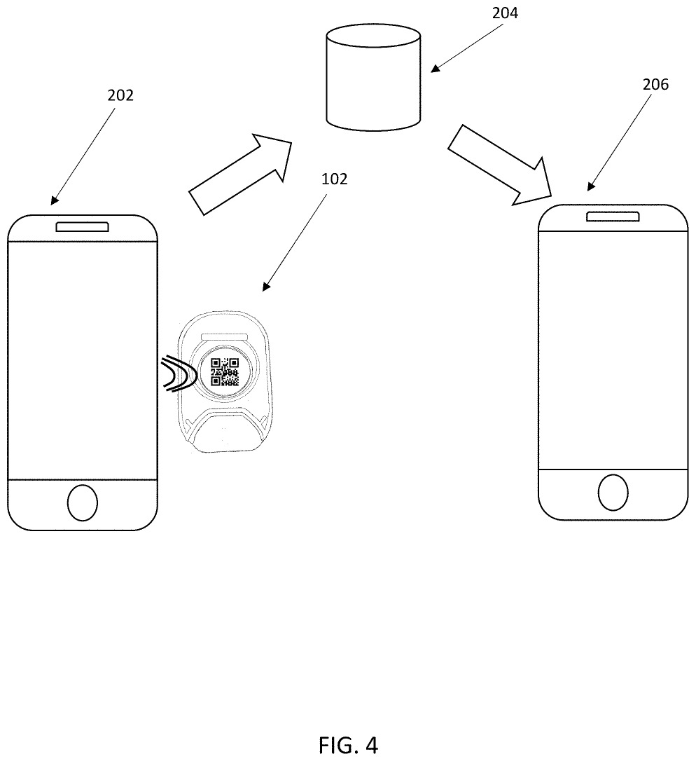

As shown in FIG. 4, after the coded image 104 is enrolled, a camera connected to an initiating mobile device 202 is able to automatically recognize the coded image 104 and send an alert to a receiving mobile device 206 associated with an enrolled phone number. In one embodiment, the alert includes a phone call and/or text message. When the alert is sent, initiating mobile device 202 does not receive information regarding the phone number to which the alert is being sent. Obscuring the recipient phone number from the initiating mobile device 202 prevents the initiating mobile device 202 from saving the phone number, which could otherwise be used to spam the recipient phone number with advertisements or other unwanted messages. In one embodiment, the alert is routed from the initiating mobile device 202 through at least one server 204 before being sent to the receiving mobile device 206. In one embodiment, when the coded image 104 is recognized by the initiating mobile device 202, a prompt appears for selecting between a phone call, text message, one-way video call, two-way video call, or another method of communication with the recipient phone number. In another embodiment, the owner of the recipient phone number is able to select which methods of communication are permitted using a website or application associated with the coded image 104. In one embodiment, the system only allows some users to set up coded images 104 enabling the use of one or more forms of communication for the alert. By way of example and not of limitation, an application associated with the coded image 104 only allows premium users (i.e., those who have paid more) to set up two-way video call during enrollment as a method of alerting the receiving mobile device 206. In one embodiment, the coded image 104 is able to be associated with more than one phone number, which is useful in situations where there is more than resident of a home or more than one owner of a vehicle or other object to which the temporary doorbell 102 is attached.

Alternatively, an NFC tag is able to be enrolled via an enrollment event, which associates the coded image 104 with a particular phone number. Before being enrolled by the user, the NFC tag is not associated with any particular phone number. In one embodiment, the NFC tag is enrolled via a user device, which detects the NFC tag and transmits information regarding the association to an enrollment database. In one embodiment, after the mobile device detects the NFC tag, a prompt is generated on the user device to select whether the NFC tag should be automatically associated with the phone number of the device being used to take the image or if different phone number should be associated with the NFC tag. In one embodiment, a prompt is generated on the user device to enter a password, biometric signature, answers to challenge questions, and/or other authentication means in association with the NFC tag. The NFC tag is operable to be disassociated from the phone number at any time via selecting an option to disassociate on a website or application associated with the NFC tag. In one embodiment, a password, biometric signature, answers to challenge questions and/or other authentication means previously associated with the NFC tag is required in order to disassociate the NFC tag from the phone number. After the NFC tag is disassociated from a phone number, detection of the NFC tag will no longer cause an alert to be transmitted to the phone number.

After the NFC tag is enrolled, other users are able to detect the NFC tag using an initiating mobile device, which will then send an alert in to the enrolled phone number. In one embodiment, the alert includes a phone call and/or text message. When the alert is sent, the user of the mobile device initiating the call and/or text message does not receive information regarding the phone number to which the alert is being sent. When the NFC tag is recognized by the initiating mobile device, a prompt appears for selecting between a phone call, text message, one-way video call, two-way video call, or another method of communication with the recipient phone number. In another embodiment, the owner of the recipient phone number is able to select which methods of communication are permitted using a website or application associated with the NFC tag. In one embodiment, the system only allows some users to set up the NFC tag enabling the use of one or more forms of communication for the alert. By way of example and not of limitation, an application associated with the NFC tag only allows premium users (i.e., those who have paid more) to set up two-way video call during enrollment as a method of alerting the mobile device.

The temporary doorbell is operable for both indoor and outdoor environments. In one example, the temporary doorbell is placed inside. Renters using a space temporarily are able to utilize the inside doorbell to communicate with the owner of the space regarding appliances within the space, issues that arise, and/or questions about the local area. In one embodiment, the temporary doorbell is associated with a specific device within a space, such that when an individual scans the temporary doorbell, the owner associated with the temporary doorbell is informed not only of the identity of the scanning individual, but also of which device about which they are calling. In another embodiment, the owner is able to set up automatic replies for certain doorbells, which provide basic instruction regarding how to use a device and/or advice about the local area. If the scanning individual is dissatisfied with the automatic reply, then the scanning individual is able to prompt to contact the owner in order to receive additional information.

In one embodiment, an alert sent to a mobile device causes the mobile device to emit a sound in order to notify the user of the mobile device. In another embodiment, the sound emitted by the mobile device becomes progressively louder until a set maximum volume until the user of the mobile device acknowledges receipt of the alert (e.g., by answering the phone). In yet another embodiment, the sound played by the mobile device in response to an alert is set by the owner of the mobile device on a website and/or application associated with the coded image and/or NFC tag. In still another embodiment, the sound emitted by the mobile device ceases after a preset amount of time.

In another embodiment, the coded image and/or NFC tag is able to be associated with a user account in addition to or instead of being associated with a phone number. In one embodiment, if the enrolling party has created a user account before enrolling the coded image and/or NFC tag, then the enrollment event will include a prompt to select whether to associate the coded image and/or NFC tag with an account or phone number. A user account includes settings for communications options with the user, including, but not limited to, phone call, one way video call, two-way video call or text message associated with a particular phone number, messages sent via social media accounts such as FACEBOOK, TWITTER, SNAPCHAT, PARLER, INSTAGRAM, LINKEDIN, WHATSAPP, LINE, KAKAOTALK, WECHAT, and/or other social media sites, email communications, and/or other communication methods. When a third party scans the coded image and/or detects the NFC tag, then an alert is sent via the selected communication methods. In one embodiment, different communication methods are able to be selected for each different coded image and/or NFC tag. In one embodiment, each coded image and/or NFC tag is able to be associated with more than one user account.

In one embodiment, the settings for each user account associated with a coded image and/or NFC tag includes status settings. If a status setting is set to “Do Not Disturb,” then the initiating mobile device is sent a denial notification, stating that the associated phone number and/or user account has not been notified of scan and that they are not receiving messages at that moment. In one embodiment, the status settings include an option to customize the message sent to the initiating mobile device during a “Do Not Disturb” period. In another embodiment, if the phone associated with the phone number and/or another device designated by the user account is turned off or out of batteries, then the status settings is automatically set to “Do Not Disturb.” In yet another embodiment, the status settings allow the recipient to receive alerts during a “Do Not Disturb” period, but still sends the denial notification to the initiating mobile device. If a status setting is set to “Incognito,” then the initiating mobile device is not sent a denial notification, but the recipient is also not sent an alert. If the status setting is set to “Normal,” then the initiating mobile device is not sent a denial notification, and the recipient phone number and/or other device designated by the user account is sent an alert.

In one embodiment, more than one communication means (e.g., more than one phone number) is able to be associated with a single temporary doorbell. In one embodiment, one or more of the communication means are associated with one or more different users and labeled accordingly. This is particularly useful in situations where more than one person lives in a household. When a visitor device scans a temporary doorbell, a menu is generated allowing the visitor device to select which user and/or communications means to contact. For example, if Bill, Steven, and Jeff all live in a location associated with the temporary doorbell, when the visitor device scans the temporary doorbell, the server is operable to receive a selection to call Bill, Steven, or Jeff. In one embodiment, one or more communications means are able to be designated as being associated with a child.

In one embodiment, a user account includes associations with devices other than a temporary doorbell, such as IoT devices. Other IoT devices (e.g., smart fridge, smart toaster, smart thermostat, etc.) are able to be enrolled in the account through NFC tags and/or coded images attached to or otherwise associated with each IoT device through an enrollment event.

In one embodiment, mobile devices are able to enroll coded images and/or NFC tags, scan coded images and/or NFC tags, and send/receive alerts without downloading a software application. The mobile device is able to automatically load at least part of an application involved in enrollment, scanning, or sending/receiving an alert in real time. Allowing users to interact with the system without downloading the app allows third party visitors to a location to automatically be able to interact with the coded image without needing to be part of the same application network as the resident.

In one embodiment, each temporary doorbell 102 is associated with at least one geofence, defining the location in which mobile devices are able to interact with the temporary doorbell 102. By way of example and not of limitation, in one embodiment, the geofence is approximately 50 feet in diameter and includes a rule limiting operable devices to those within the geofence. This means that the device scanning the coded image 104 must be within 50 feet of the coded image 104 in order for any alert to be sent. This helps to prevent abuse of the temporary doorbell 102, in which a photograph of the coded image 104 is taken and used at a later time to spam the recipient phone number with unwanted messages. In another embodiment, the geofence automatically sends an alert to a user when someone is approaching the doorbell, before the doorbell is actually used. In one embodiment, the geofence works by uploading the user's geolocation to a network and then determining whether the geolocation is within a certain range of an established geofence. In a preferred embodiment, devices in the system are able to directly communicate locations with one another such that, for example, a mobile device is able to determine its relative position to a temporary doorbell and vice versa. Direct communications between devices is advantageous as it never requires user information to be transmitted and saved in an outside location and because it allows use of a geofence without any network connection. Bidirectional communication of geospatial location is enabled between devices of the system, as described in U.S. Patent Publication No. 2013/0031260, which is incorporated by reference herein in its entirety. In one embodiment, the NFC tag and/or coded image further includes a BLUETOOTH beacon, which automatically sends an alert to a recipient phone number and/or user account when a mobile device enters a predetermined range of the BLUETOOTH beacon.

In one embodiment, the temporary doorbell and each mobile device associated with the system have unique Internet Protocol (IP) addresses. In one embodiment, as described in U.S. Pat. No. 10,237,232, which is incorporated by reference herein in its entirety, the unique IP addresses are Internet Protocol version 6 (IPv6) devices. In one embodiment, at least one of the unique IP addresses is encoded as at least one anchor point, including location data and metadata, wherein the metadata includes at least one class, entitlement, and/or lookup table identifiers.

In one embodiment, an account associated with the at least one coded image or at least one NFC tag includes a whitelist and/or blacklist. By enabling a whitelist, the account is operable to define a limited list of phone numbers and/or user accounts that are capable of interacting with the coded image and/or NFC tag. By enabling a blacklist, the account is operable to define a limited list of phone numbers and/or user accounts that are incapable of interacting with the coded image and/or NFC tag. In one embodiment, the whitelist and/or blacklist are able to be used not only to define who is able to interact with the coded image and/or NFC tag, but the methods of communication (e.g., two-way video, one-way video, text, etc.) that each user account and/or phone number is capable of using in order to send an alert.

In one embodiment, the system records identifying information regarding each device used to scan the coded image and stores the identifying information in a database. In a preferred embodiment, if a cellular phone is used to scan the coded image, then the system automatically records the phone number associated with the cellular phone. In another embodiment, if the device used to scan the coded image is currently logged into a user account through the system, then the system automatically records the user account associated with the device used to scan the coded image. In one embodiment, when the alert is sent to the recipient phone number and/or user account, the recipient receives information regarding the phone number and/or user account of the initiating device in real time. In another embodiment, information regarding past initiating devices for each coded image and/or NFC tag are viewable via a user account associated with each coded image and/or NFC tag.

In one embodiment, there is a mandatory time delay between each alert sent through a particular coded image. For example, in one embodiment, a three-minute delay is imposed, such that once one mobile device scans the coded image to send the alert, another alert cannot be sent through that coded image for another three minutes. In another embodiment, a mandatory time delay is only imposed on each initiating mobile device with respect to a particular QR code. For example, in one embodiment, a three-minute delay is imposed, such that once a first mobile device scans the coded image to send the alert, another alert cannot be sent via the first mobile device for another three minutes, but the coded image is able to be used by a second mobile device to send an alert within those three minutes. In one embodiment, the mandatory time delay between each alert is enabled, disabled, and/or modified through the modification of settings of a user account associated with the coded image.

In one embodiment, after an alert is sent to a recipient device, a prompt is generated, allowing the recipient device is select an amount of time before the recipient is able to arrive. By way of example and not of limitation, in one embodiment, the prompt includes a list of buttons such as “Coming Now,” “5 minutes,” “30 minutes, “Not Coming,” and/or other specific time periods. In another embodiment, a user account associated with each coded image and/or NFC tag includes a setting allowing a user to generate a preset list of responses to an alert for each coded image and/or NFC tag. In yet another embodiment, a response to the alert is automatically generated based on the distance of the recipient device from the initiating mobile device. After an amount of time is entered or a selection one of the number of preset options is made, a response message is automatically sent to the initiating mobile device, containing information regarding the response to the prompt.

In one embodiment, the temporary doorbell includes a demo mode. Demo mode allows for the temporary doorbell to be associated with a phone number and/or user account for a limited amount of time or until the temporary doorbell is manually dissociated with the phone number and/or user account. During the duration of the demo period, user devices scanning the NFC tag and/or coded image associated with the temporary doorbell are able to send alerts and/or notifications to the phone number and/or user account temporarily associated with the temporary doorbell.

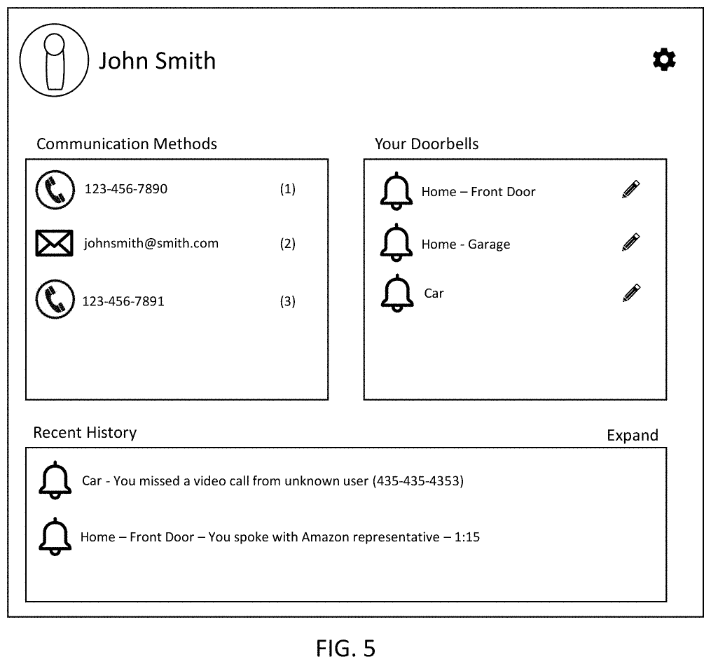

FIG. 5 illustrates a user dashboard for a management system for one or more temporary doorbells according to one embodiment of the present invention. In one embodiment, the system includes a management application operable to be accessed from a user device. The management application includes a user dashboard. In one embodiment, the user dashboard includes a name, a username, a profile picture, a button to visit a settings page, a list of all communication methods associated with the user profile, a list of all temporary doorbells associated with the user profile, and/or a list of recent history events (e.g., recent notification events and calls associated with the temporary doorbells). In one embodiment, each of the listed communication methods includes an assigned numerical shorthand (e.g., one phone number is designated as contact means #1, an email address is designated as contact means #2, etc.). In one embodiment, the list of recent history events includes which temporary doorbell was used, what form of communication was used (e.g., video call, audio call, text message, etc.), whether the user responded to the message and/or picked up the call, an amount of time spent on the call if answered, and/or a user profile name, phone number, and/or device ID associated with the visitor device initiating the communication.

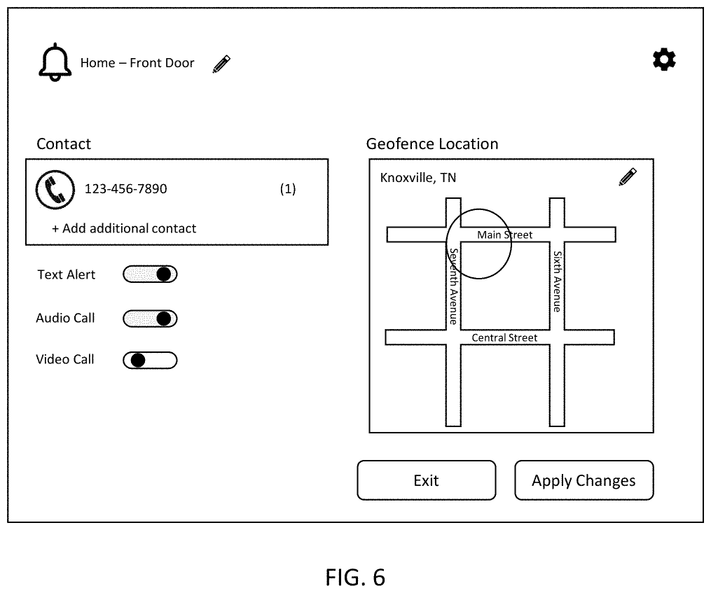

FIG. 6 illustrates a device manager page for a management system for one or more temporary doorbells according to one embodiment of the present invention. In one embodiment, a device manager page includes a name of the temporary doorbell, an option to edit the name of the temporary doorbell, one or more contact methods associated with the temporary doorbell, an option to add an additional contact method associated with the temporary doorbell, an option to enable text alerts, an option to enable audio calls, an option to enable video calls, a map showing the location of a geofence associated with the temporary doorbell, and an option to edit the geofence associated with the temporary doorbell. In one embodiment, the device manager page includes an option to designate one form of communication (e.g., audio call, video call) as the default form of communication automatically initiated whenever a visitor device interacts with the temporary doorbell. In another embodiment, the device manager page includes an option to enable a plurality of forms of communication and a server is operable to receive a selection of one of the plurality of forms of communication from the visitor device at the time that the visitor device interacts with the temporary doorbell.

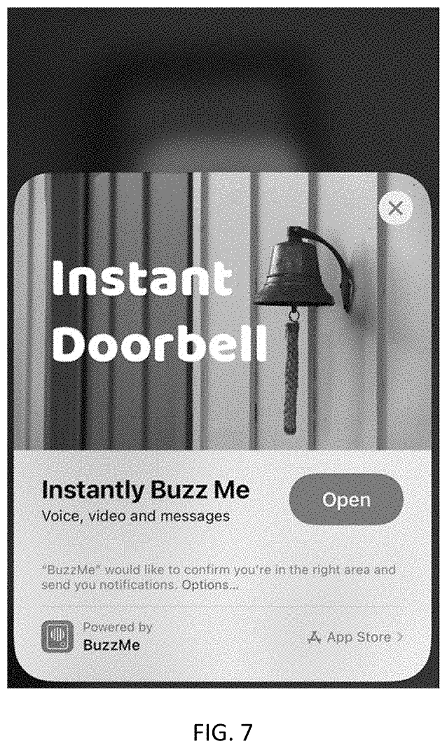

FIG. 7 illustrates a push notification to open an application generated upon scanning a coded image according to one embodiment of the present invention. In one embodiment, when the coded image is scanned, a prompt to open an application associated with the coded image on the scanning user device is automatically generated. In one embodiment, if the scanning user device is not associated with an existing profile on the application, then the scanning user device is sent a prompt to sign in to the application. In one embodiment, if the scanning user device is associated with an existing profile on the application, accepting the prompt causes the application to automatically open.

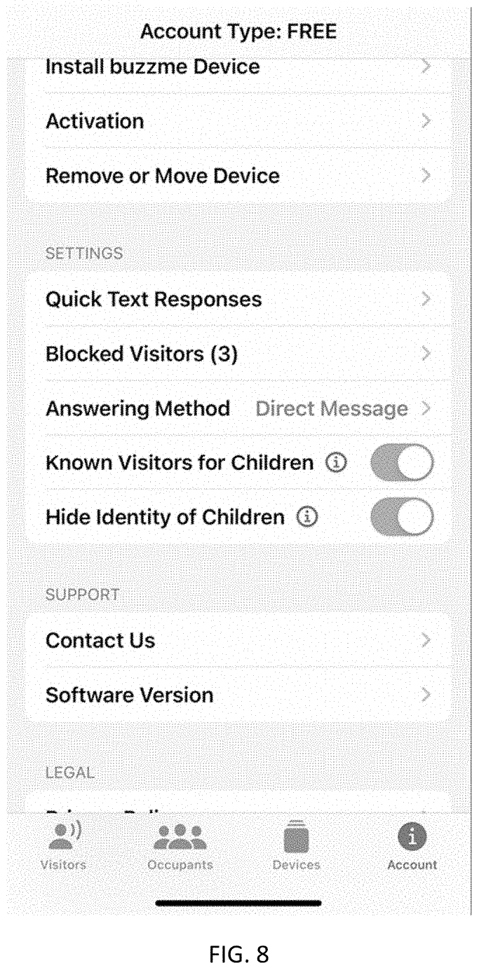

FIG. 8 illustrates a settings GUI according to one embodiment of the present invention. In one embodiment, the user profile includes a plurality of settings concerning one or more of the temporary doorbells. In one embodiment, the user profile includes a setting to change the answering method (e.g., phone call, video call, text message, etc.) for a specific temporary doorbell and/or for all temporary doorbells associated with the account. In one embodiment, the user profile includes a setting to block specific visitors from utilizing one or more temporary doorbells associated with the account. If a visitor device is blocked, then that visitor device is unable to message or call the communication means associated with the temporary doorbell. In one embodiment, if a visitor device is blocked and attempts to utilize the temporary doorbell, then an alert is automatically transmitted to the communication means associated with the temporary doorbell. In one embodiment, the settings include an option to hide identities of children associated with one or more of the temporary doorbells. In one embodiment, the settings include an option to hide identities of children who access the temporary doorbell (i.e., not to show a name of the children in a visitor history GUI).

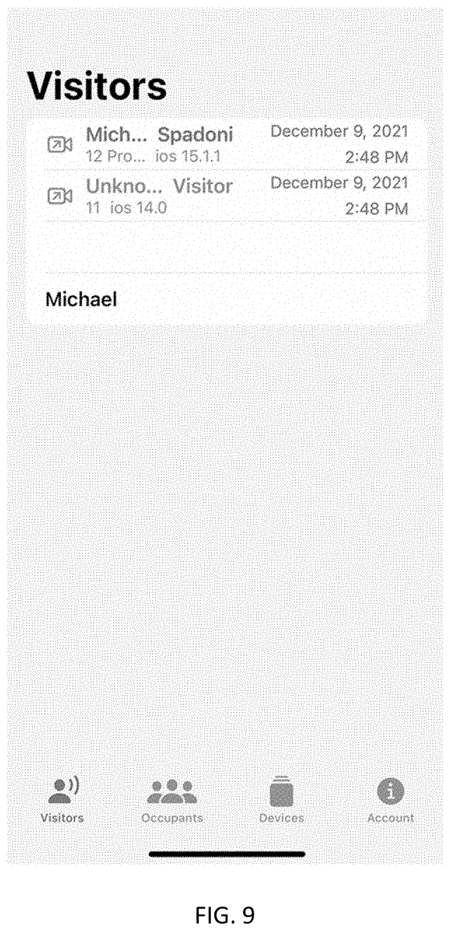

FIG. 9 illustrates a visitor history GUI according to one embodiment of the present invention. In one embodiment, the system generates a visitor history GUI including a list of visitor devices that have used or attempted to use one or more of the temporary doorbells associated with a user profile within a given time period. In one embodiment, the visitor history GUI includes a name of the visitor, a date the temporary doorbell was accessed, a time the temporary doorbell was accessed, a method of communication (e.g., video call, phone call, text message, etc.), whether the call was answered by the user, and/or a duration of a call.

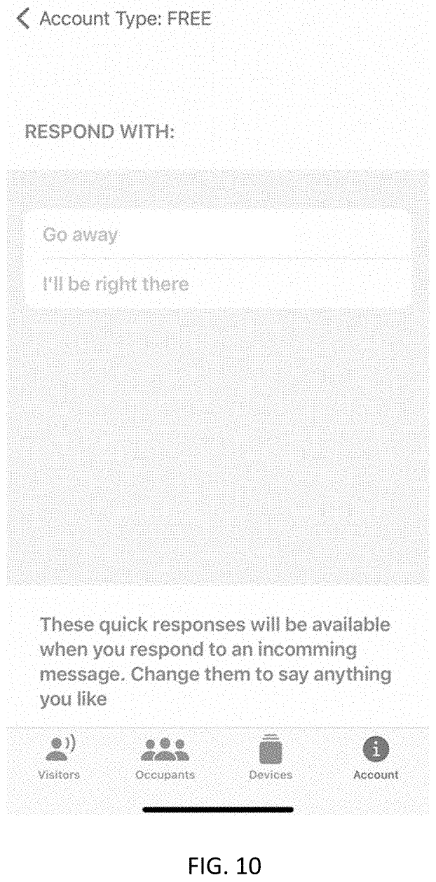

FIG. 10 illustrates a quick response settings GUI according to one embodiment of the present invention. In one embodiment, the settings include an option to enable a quick response message and/or to change the content of the quick response message. In one embodiment, if a single quick response message is enabled then the quick response message is automatically transmitted to the visitor device when the visitor device attempts to access the temporary doorbell. In another embodiment, when the visitor device access the temporary doorbell, a message is transmitted to the user device. The user device is able to quickly select one or more of the quick response messages set in the settings of the user profile in order to quickly respond to the visitor (e.g., to allow the user to enter, to refuse entry, etc.). In one embodiment, the quick response settings GUI is operable to receive a selection to change one or more of the preset quick response messages for a user profile.

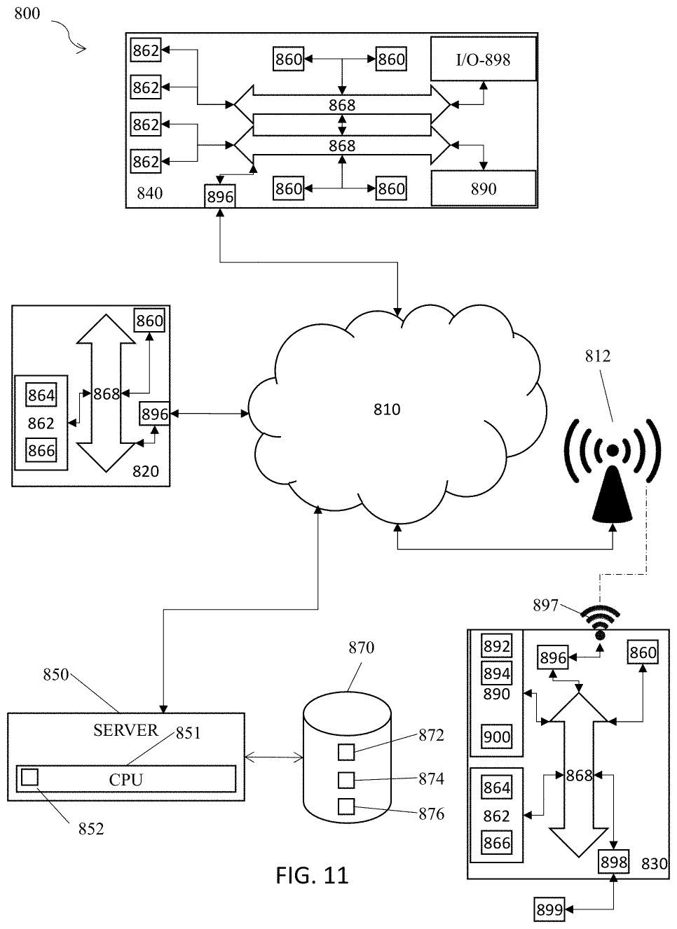

FIG. 11 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random-access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 11, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 11, is operable to include other components that are not explicitly shown in FIG. 11, or is operable to utilize an architecture completely different than that shown in FIG. 11. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The above-mentioned examples are provided to serve the purpose of clarifying the aspects of the invention, and it will be apparent to one skilled in the art that they do not serve to limit the scope of the invention. By nature, this invention is highly adjustable, customizable and adaptable. The above-mentioned examples are just some of the many configurations that the mentioned components can take on. All modifications and improvements have been deleted herein for the sake of conciseness and readability but are properly within the scope of the present invention.

The invention claimed is:

1. A system for providing an alert, comprising:
a housing;
at least one unique identifier within the housing, wherein the at least one unique identifier includes at least one coded image and/or at least one near-field communication (NFC) tag;
a server, including a processor and a database, in network communication with at least one communication device;
wherein the at least one unique identifier is enrolled to associate the at least one unique identifier with the at least one communication device;
wherein the association between the at least one unique identifier and the at least one communication device is stored in the database;
wherein, when the at least one unique identifier is scanned or detected by at least one visitor device, a message is automatically transmitted to the at least one communication device and/or a call is automatically initiated between the at least one communication device and the at least one visitor device; and
wherein the at least one visitor device includes at least one smart phone, at least one tablet, and/or at least one wearable device.

2. The system of claim 1, wherein the server is operable to receive a notification of a scan of the at least one unique identifier by the at least one visitor device and automatically transmit the message to the at least one communication device.

3. The system of claim 1, wherein the housing includes an ultraviolet (UV) overlaminate applied to an external surface of the housing.

4. The system of claim 1, wherein the message is automatically transmitted via a WI-FI network or a cellular network, and/or wherein the call is automatically initiated over a WI-FI network or a cellular network.

5. The system of claim 1, wherein the at least one unique identifier includes at least one second coded image, and wherein the at least one unique identifier is automatically enrolled to associate the at least one unique identifier with the at least one communication device when the at least one second coded image is scanned by the at least one communication device.

6. The system of claim 1, wherein the database is operable to store at least one user profile associated with the at least one communication device.

7. The system of claim 6, wherein the at least one user profile includes preference information, and wherein the preference information includes one or more forms of communication able to be initiated when the at least one unique identifier is scanned and/or detected.

8. The system of claim 1, wherein the server is operable to receive location data from the at least one visitor device, wherein the at least one unique identifier is associated with a geofence and wherein the message is not transmitted to the at least one communication device and/or the call is not initiated between the at least one communication device and the at least one visitor device if the at least one visitor device is detected to be outside the geofence based on the received location data.

9. The system of claim 1, wherein an external surface of the housing includes an adhesive material.

10. A system for providing an alert, comprising:
at least one unique identifier, wherein the at least one unique identifier includes at least one coded image and/or at least one near-field communication (NFC) tag;
a server, including a processor and a database, in network communication with at least one communication device;
wherein the at least one unique identifier is enrolled to associate the at least one unique identifier with the at least one communication device;
wherein the association between the at least one unique identifier and the at least one communication device is stored in the database;
wherein the at least one unique identifier is associated with a geofence;
wherein, when the at least one unique identifier is scanned or detected by at least one visitor device, a message is automatically transmitted to the at least one communication device and/or a call is automatically initiated between the at least one communication device and the at least one visitor device;
wherein the server is operable to receive location data from the at least one visitor device; and
wherein the message is not transmitted to the at least one communication device and/or the call is not initiated between the at least one communication device and the at least one visitor device if the at least one visitor device is detected to be outside the geofence based on the received location data.

11. The system of claim 10, wherein the server is operable to receive a notification of a scan of the at least one unique identifier by the at least one visitor device and automatically transmit the message to the at least one communication device.

12. The system of claim 10, wherein the message is automatically transmitted via a WI-FI network or a cellular network, and/or wherein the call is automatically initiated over a WI-FI network or a cellular network.

13. The system of claim 10, wherein the at least one unique identifier includes at least one second coded image, and wherein the at least one unique identifier is automatically enrolled to associate the at least one unique identifier with the at least one communication device when the at least one second coded image is scanned by the at least one communication device.

14. The system of claim 10, wherein the database is operable to store at least one user profile associated with the at least one communication device.

15. The system of claim 14, wherein the at least one user profile includes preference information, and wherein the preference information includes one or more forms of communication able to be initiated when the at least one unique identifier is scanned and/or detected.

16. The system of claim 10, further comprising at least one beacon, wherein the at least one beacon is positioned proximate to the at least one unique identifier, and wherein boundaries of the geofence are set by the at least one beacon.

17. A system for providing an alert, comprising:
a housing, including an inner chamber;
a server, including a processor and a database, in network communication with at least one communication device;
at least one unique identifier positioned within the inner chamber of the housing, wherein the at least one unique identifier includes at least one coded image and/or at least one near-field communication (NFC) tag;
wherein the at least one unique identifier is enrolled to associate the at least one unique identifier with at least one communication device;
wherein the association between the at least one unique identifier and the at least one communication device is stored in the database; and
wherein, when the at least one unique identifier is scanned or detected by at least one visitor device, a message is automatically transmitted to the at least one communication device and/or a call is automatically initiated between the at least one communication device and the at least one visitor device.

18. The system of claim 17, wherein the at least one unique identifier is configured to ejected from the housing when sufficient pressure is applied to a front surface of the housing.

19. The system of claim 17, wherein the housing includes an ultraviolet (UV) overlaminate applied to an external surface of the housing.

20. The system of claim 17, wherein an external surface of the housing includes an adhesive material.
